(19) United States
(12) Patent Application Publication
(10) Pub. No.: US 2010/0141135 A1
(43) Pub. Date: Jun. 10, 2010

(54) DISPLAY DEVICE MANUFACTURING METHOD AND APPARATUS THEREOF

(75) Inventors: Satoru KASE, Mobara (JP); Yoshinori Ishii, Chiba (JP); Eiji Matsuzaki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/630,862

(22) Filed: Dec. 4, 2009

(30) Foreign Application Priority Data
Dec. 4, 2008 (JP) 2008-309527

(51) Int. Cl. H01J 1/62; H01J 9/26; H01J 9/46

(52) U.S. Cl. 313/512; 445/25; 445/66

(57) ABSTRACT

The present invention provides a manufacturing method of a display device which can favorably cut a display panel having the structure where a resin layer is sandwiched between an element substrate and a sealing substrate. The manufacturing method of a display device includes the steps of: forming a display panel by sandwiching a resin which is hardened by any one of electromagnetic waves, radioactive rays and electron beams and heat between an element substrate having a display region in which a plurality of light emitting elements are formed and a sealing substrate in such a manner that the resin covers the display region; radiating at least one of electromagnetic waves, radioactive rays and electron beams to the display panel thus hardening first portions of the resin and leaving second portions of the resin in a state softer than the first portions; separating the display panel at positions corresponding to the second portions; and heating the separated display panel thus further hardening the resin.

### CROSS-REFERENCE TO RELATED APPLICATIONS

The present application claims priority from Japanese Application JP 2008-309527 filed on Dec. 4, 2008, the content of which is hereby incorporated by reference into this application.

### BACKGROUND OF THE INVENTION

1. Field of the Invention

The present invention relates to a manufacturing method of a display device, a manufacturing apparatus of a display device, and a display device, and more particularly to a manufacturing method of a display device having a display region in which a plurality of light emitting elements are formed, a manufacturing apparatus of a display device, and a display device.

2. Background Art

Recently, there has been proposed a display device which displays various kinds of information by integrating a large number of light emitting elements on a substrate. As a typical example of such a display device, an organic electroluminescence display (OLED) which makes use of emission of light by electroluminescence can be named. Conventionally, with respect to such an organic electroluminescence display, to protect elements formed on a substrate, in forming a display panel, a sealing material is applied to the substrate such that the sealing material surrounds a periphery of a display part, and sealing glass is adhered to the substrate. A space is defined between the substrate and the sealing glass, and an inert gas and a desiccant are sealed in the space.

The above-mentioned sealing method is referred to as hollow sealing. Such a sealing method, however, has drawbacks including following drawbacks. That is, it is necessary to perform working for forming recessed portions in the sealing glass. Coating of the sealing material requires time. When the sealing glass is deflected and comes into contact with an element on the substrate, there arises a possibility that the element is broken. Accordingly, it is preferable to adopt total sealing which is a sealing method where all elements on a substrate are covered with a resin, and sealing glass is adhered to the resin from above.

However, the total sealing produces a panel having the structure where a hardened resin layer is sandwiched between the substrate and the sealing glass and hence, cutting of the panel becomes difficult. Currently, a scribe-break method has been popularly used as a method for cutting a panel. However, in applying such a method to the panel having the resin layer, a crack which is formed in glass in a scribing step stops at the resin layer so that the hardened resin layer cannot be cut. Accordingly, the use of the scribe-break method gives rise to not only a possibility that a sharp cutting surface cannot be obtained but also a possibility that the panel per se is broken.

On the other hand, to increase production efficiency of display devices, it is necessary to use a so-called multiple-piece simultaneous manufacturing method where a panel is prepared by forming a large number of display devices on a large substrate, and the respective display devices are obtained by cutting the panel. Accordingly, it is necessary to apply a technique which ensures favorable cutting of a panel and enables multiple-piece simultaneous manufacturing even to the display device which adopts the total sealing.

In this respect, JP-A-2005-322633 (patent document 1) describes a method where a large number of display parts are formed on a substrate, a sealing material is applied to the substrate such that the sealing material surrounds the peripheries of the respective display parts, a resin is filled in the inside of the respective display parts surrounded by the sealing material, and sealing glass is adhered to the substrate (see FIG. 2 or the like).

### SUMMARY OF THE INVENTION

According to the method disclosed in patent document 1, a portion which is not filled with the resin is formed between the display parts and hence, it is considered that no particular problem arises in cutting a panel. However, such a method requires a complicated and time-consuming step where the sealing material is applied to the substrate such that the sealing material surrounds the peripheries of the plurality of display parts individually, and the resin is filled in the inside of the respective display parts surrounded by the sealing material. Accordingly, it is impossible to sufficiently enhance the production efficiency of the display device.

The present invention has been made in view of such drawbacks, and it is an object of the present invention to provide a manufacturing method and a manufacturing apparatus of a display device which can favorably cut a display panel having the structure where a resin layer is sandwiched between the element substrate and the sealing substrate, and a display device manufactured by such a method.

To briefly explain the summary of typical inventions among inventions described in this specification, they are as follows.

(1) According to one aspect of the present invention, there is provided a manufacturing method of a display device which includes the steps of: forming a display panel by sandwiching a resin which is hardened by any one of electromagnetic waves, radioactive rays and electron beams and heat between an element substrate having a display region in which a plurality of light emitting elements are formed and a sealing substrate in such a manner that the resin covers the display region; radiating at least one of electromagnetic waves, radioactive rays and electron beams to the display panel thus hardening first portions of the resin and leaving second portions of the resin in a state softer than the first portions; separating the display panel at positions corresponding to the second portions; and heating the separated display panel thus further hardening the resin.

(2) In the manufacturing method of a display device having the constitution (1), the element substrate has a plurality of display regions, and the second portions include portions each of which is sandwiched between every two display regions out of the plurality of display regions.

(3) In the manufacturing method of a display device having the constitution (1), the resin covers the display regions and the second portions include the display regions.

(4) In the manufacturing method of a display device having the constitution (1), at least one of electromagnetic waves, radioactive rays and electron beams is blocked partially in the radiation step thus leaving the second portions.

(5) In the manufacturing method of a display device having the constitution (1), in the separation step, the display panel is separated by applying scribing to at least one of the element substrate and the sealing substrate and, thereafter, by breaking the display panel.

(6) According to another aspect of the present invention, there is provided a manufacturing apparatus of a display device which includes: a panel forming device which forms a display panel by sandwiching a resin which is hardened by any one of electromagnetic waves, radioactive rays and electron beams and heat between an element substrate having a display region in which a plurality of light emitting elements are formed and a sealing substrate in such a manner that the resin covers the display region; a radiation device which radiates at least one of electromagnetic waves, radioactive rays and electron beams to the display panel thus hardening first portions of the resin and leaving second portions of the resin in a state softer than the first portions; a separation device which separates the display panel at positions corresponding to the second portions; and a heating device which heats the separated display panel thus further hardening the resin.

(7) In the manufacturing apparatus of a display device having the constitution (6), the radiation device partially blocks at least one of electromagnetic waves, radioactive rays and electron beams.

(8) In the manufacturing apparatus of a display device having the constitution (6), the separation device separates the display panel by applying scribing to at least either one of the element substrate and the sealing substrate and, thereafter, by breaking the display panel.

(9) According to still another aspect of the present invention, there is provided a display device which includes: an element substrate which includes a display region in which a plurality of light emitting elements are formed; a sealing substrate; and a resin layer which is sandwiched between the element substrate and the sealing substrate and covers the display region, wherein on at least one side of the display device, a region at an edge portion of the resin layer exhibits a higher thermal hardening rate and a lower radiation hardening rate attributed to at least one of electromagnetic waves, radioactive rays and electron beams compared to a region inside the region at the edge portion of the resin layer.

(10) In the display device having the constitution (9), a region of the resin layer which corresponds to the display region exhibits a higher thermal hardening rate compared to the region inside the region at the edge portion of the resin layer.

According to the above-mentioned inventions, it is possible to provide the manufacturing method of a display device, the manufacturing apparatus of a display device which can favorably cut the display panel having the structure where the resin layer is sandwiched between the element substrate and the sealing substrate, and the display device manufactured by the manufacturing method.

### BRIEF DESCRIPTION OF THE DRAWINGS

FIG. 1 is a schematic view of a manufacturing apparatus of a display device according to a first embodiment;

FIG. 2 is a view for explaining a manufacturing method of a display device according to the first embodiment; and

FIG. 3 is a view for explaining a manufacturing method of a display device according to a second embodiment.

### DETAIL DESCRIPTION OF THE EMBODIMENTS

Hereinafter, a first preferred embodiment of the present invention is explained in conjunction with drawings.

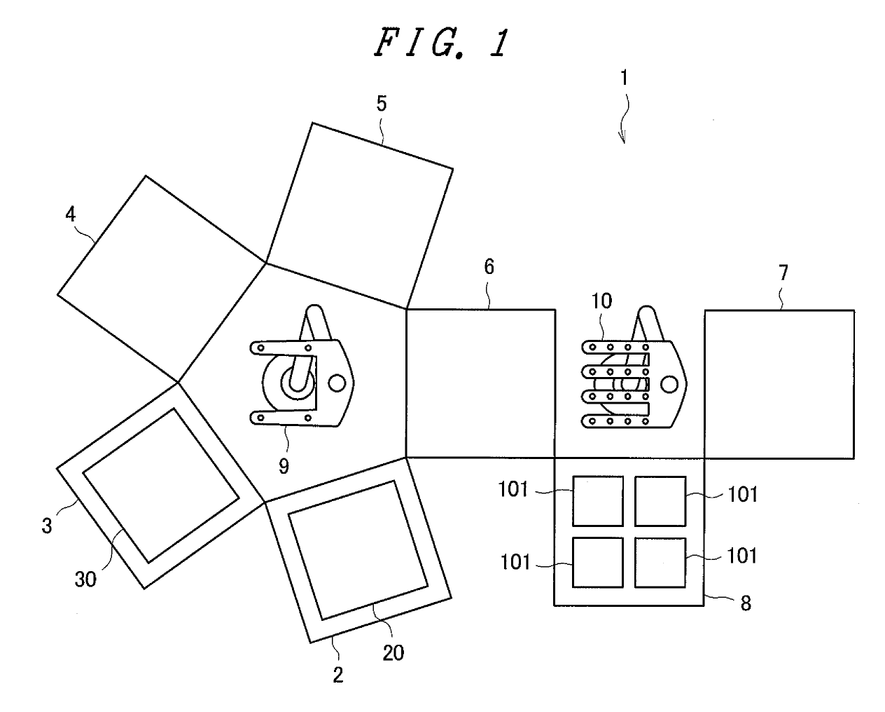

FIG. 1 is a schematic view of a manufacturing apparatus 1 of a display device 101 according to this embodiment. FIG. 1 shows a state of the manufacturing apparatus 1 as viewed in a plan view. The manufacturing apparatus 1 is constituted of an element substrate receiving portion 2, a sealing substrate receiving portion 3, an adhesion device 4, a radiation device 5, a separation device 6, a heating device 7, a delivery portion 8, a receiving-side conveying device 9 and a delivery-side conveying device 10.

The element substrate receiving portion 2 is a buffer which receives and stocks an element substrate 20 on which a plurality of light emitting elements are formed, and the sealing substrate receiving portion 3 is a buffer which receives and stocks a sealing substrate 30. The element substrate 20 and the sealing substrate 30 are conveyed from a preceding step using an arbitrary conveying means such as a conveying robot or a conveyer. The adhesion device 4 is a device which forms a display panel by adhering the element substrate 20 and the sealing substrate 30 to each other with a resin sandwiched therebetween. The radiation device 5 is a device which radiates at least one of electromagnetic waves, radioactive rays and electron beams to the display panel thus temporarily hardening the resin. Here, temporary hardening implies hardening to an extent that the resin is not completely hardened. The separation device 6 is a device which cuts and separates the display panel by a scribe-break method.

The conveyance of the element substrate 20, the sealing substrate 30 and the display panel among the element substrate receiving portion 2, the sealing substrate receiving portion 3, the adhesion device 4, the radiation device 5 and the separation device 6 is performed by the receiving-side conveying device 9. In the drawing, the receiving-side conveying device 9 is illustrated as a scalar-type robot provided with a suction hand. However, the receiving-side conveying device 9 is not limited to such a robot, and any device can be used provided that the device can convey the element substrate 20, the sealing substrate 30 and the display panel.

The heating device 7 is a device which hardens the resin by heating the separated display panel. As the heating device 7, various kinds of heating devices such as a hot plate, a hot-air heating device or an infrared heating device can be used. The delivery portion 8 is a buffer which stocks an obtained display device 101 and, at the same time, delivers the display device 101 to a succeeding step using an arbitrary conveyance means such as a conveying robot or a conveyer.

In this embodiment, the manufacturing apparatus 1 is described as a so-called station-type manufacturing apparatus which includes the element substrate receiving portion 2, the sealing substrate receiving portion 3 and the delivery portion 8 and, at the same time, performs the conveyance of the display panel among the respective devices using the robots. However, the manufacturing apparatus 1 is not limited to such a station-type manufacturing apparatus, and may be a so-called line-type manufacturing apparatus where a product flows toward a down stream side from an upper stream side. Further, with respect to the respective devices, one set of device is provided for each device in the drawing. However, the number of devices for the same device is not limited, and a plurality of devices may be provided for the same device. Further, devices not shown in the drawing may be provided additionally. As one example, a polishing device which polishes an edge surface of the display device 101, a cleaning device or the like may be added.

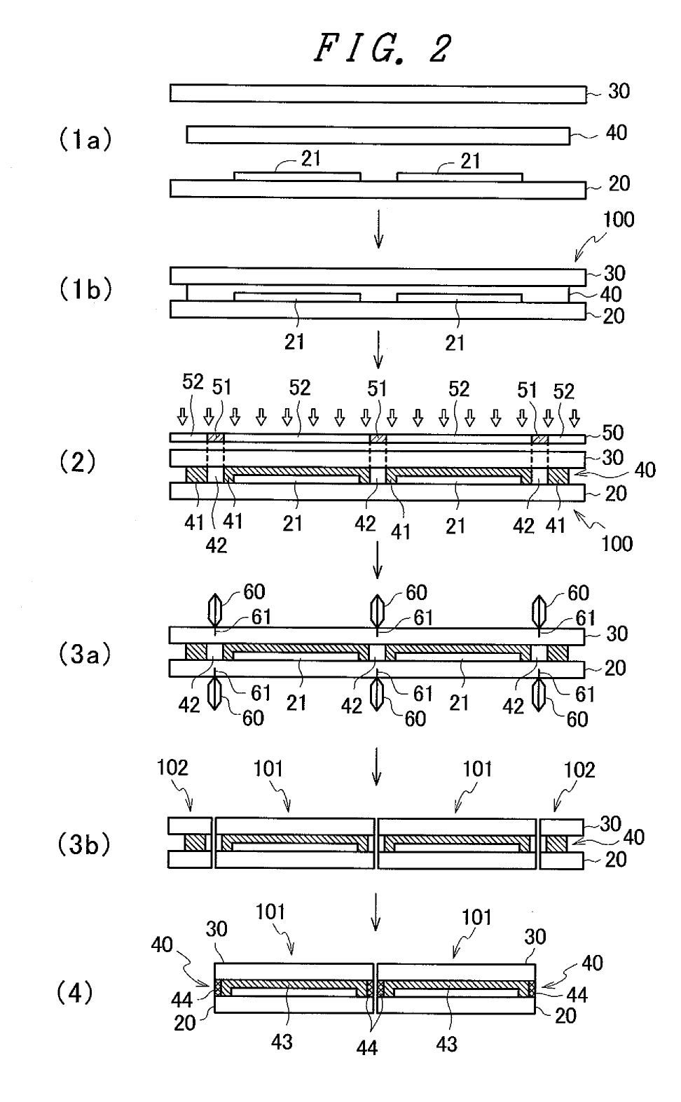

Next, a manufacturing method of the display device 101 using the manufacturing apparatus 1 is explained in conjunction with FIG. 2.

A first step is a panel forming step indicated by (1a) and (1b) in FIG. 2. In this step, a resin 40 is sandwiched between an element substrate 20 and a sealing substrate 30 by an adhesion device 4 thus forming a display panel 100. The element substrate 20 and the sealing substrate 30 are introduced by the receiving-side conveying device 9.

In FIG. 2, (1a) is a cross section schematically showing a mode in which the resin 40 is sandwiched between the element substrate 20 and the sealing substrate 30. A plurality of display regions 21 each of which forms a plurality of light emitting elements therein are formed on the element substrate 20. As shown in the drawing, a slight gap is formed between the respective display regions 21. In this embodiment, the element substrate 20 which adopts a so-called four-piece simultaneous manufacturing is shown in the drawing. That is, two display regions 21 are arranged in the long-side direction of the element substrate 20 as well as in the short-side direction of the element substrate 20 respectively so that four display regions 21 are arranged in total on the whole surface. However, such an element substrate 20 is illustrated for the sake of brevity, and an arbitrary number of display regions 21 may be formed on the element substrate 20. That is, six-piece simultaneous manufacturing, eight-piece simultaneous manufacturing, twenty-piece simultaneous manufacturing or the like may be adopted. It is needless to say that single-piece manufacturing in which only one display region 21 is formed on the element substrate 20 or two-piece simultaneous manufacturing in which two display regions 21 are formed on the element substrate 20 may also be adopted. Although the element substrate 20 is preferably made of glass, the element substrate 20 may be made of other materials such as ceramics. The resin 40 has property of being hardened by any one of electromagnetic waves, radioactive rays and electron beams and heat. In this embodiment, an ultraviolet hardening epoxy resin is used as the resin 40. However, the resin 40 is not limited to such a resin. Further, as a method for applying the resin 40 to the element substrate 20 and the sealing substrate 30, the resin 40 in a liquid form is dropped on either one of the element substrate 20 and the sealing substrate 30 and, thereafter, the resin 40 may be sandwiched between both substrates 20, 30. Alternatively, the resin 40 formed into a flexible sheet by molding may be applied to either one of the element substrate 20 and the sealing substrate 30 and, thereafter, the resin 40 may be sandwiched between both substrates 20, 30. Although the sealing substrate 30 is preferably made of glass, the sealing substrate 30 may preferably be made of other materials such as ceramics.

At this point of time, the resin 40 is not hardened so that the resin 40 is soft. Accordingly, when the resin 40 is sandwiched between the element substrate 20 and the sealing substrate 30, as indicated by (1b) in FIG. 2B, the resin 40 is deformed following the unevenness of a surface shape of the display regions 21, and is filled so as to cover at least the display regions 21 without forming any gap between both substrates. In this embodiment, the resin 40 is uniformly filled between the element substrate 20 and the sealing substrate 30 over the substantially whole surface of these substrates except for edge portions of the substrates. However, the resin 40 may be filled also into the edge portions of these substrates. The display panel 100 formed in this manner is conveyed to the radiation device 5 by the receiving-side conveying device 9.

The next step is a radiation step indicated by (2) shown in FIG. 2. In this step, the resin 40 is temporarily hardened by the radiation device 5. In the drawing, a white bordered arrow indicates ultraviolet rays for hardening the resin. Here, depending on the property of the resin 40, electromagnetic waves, radioactive rays or electron beams may be radiated to the resin 40 when necessary. In this radiation step, a mask 50 is used for blocking some ultraviolet rays. The mask 50 is constituted of ray blocking portions 51 which are portions for blocking ultraviolet rays and ray transmitting portions 52 which are portions for allowing the transmission of ultraviolet rays therethrough. First portions 41 of the resin 40 are temporarily hardened by receiving the radiation of ultraviolet rays. On the other hand, second portions 42 of the resin 40 do not receive the radiation of ultraviolet rays and hence, the second portions 42 are not hardened and remain soft. The second portions 42 are formed in regions each of which is sandwiched by the display regions 21 and on edge portions of the display panel 100.

Here, although the degree of temporary hardening depends on property of the resin 40, assume a radiation quantity of ultraviolet rays for completely hardening the resin 40 as 100, it is preferable to set the radiation quantity of ultraviolet rays to approximately 10 to 50, and it is more preferable to set the radiation quantity of ultraviolet rays to approximately 20 to 40. Further, in this embodiment, the ultraviolet rays are not radiated to the second portions 42 so that the second portions are not hardened. However, it is not always necessary to prevent the second portions 42 from being completely hardened. As described later, provided that the second portions 42 are soft to an extent that the display panel 100 can be separated, the second portions 42 may be hardened by radiating ultraviolet rays to the second portions 42. In any case, the second portion 42 remain in a soft state compared to the first portions 41 which fix the positional relationship between the element substrate 20 and the sealing substrate 30.

Further, in this embodiment, the radiation device 5 uses the mask 50 for blocking ultraviolet rays. However, ultraviolet rays may be radiated to only necessary portions of the resin 40 without using the mask 50.

After the radiation step is finished, the display panel 100 is conveyed to the separation device 6 using the receiving-side conveying device 9.

The next step is a separation step indicated by (3a) and (3b) in FIG. 2. In this step, the display panel 100 is separated or divided into individual display devices 101 by the separation device 6. The separation device 6 cuts the display panel 100 by a scribe-break method.

Firstly, as schematically indicated by (3a) in FIG. 2, a surface of the element substrate 20 and a surface of the sealing substrate 30 are scribed by scribing wheels 60 along lines for separating the display panel 100, and cracks 61 are generated on the surfaces of the respective substrates. This step is called scribing. The scribing wheel 60 is a tool having a sharp edge which is made of a super hard alloy, a diamond sintered body or the like. By pressing the scribing wheel 60 to a surface of a substrate made of glass or the like with a predetermined force, it is possible to generate cracks on the surface of the substrate. As a tool of this type, a disc-shaped scribing wheel 60 used in this embodiment is often used. However, the scribing wheel 60 may have other shape such as a pin shape or a blade shape. Positions where the crack 61 is generated are positions where the display panel 100 is separated, that is, the regions each of which is sandwiched between the display regions 21 and the edge portions of the display panel 100. At positions which correspond to such positions, the second portions 42 are formed as shown in the drawing. In this embodiment, scribing is performed from both surfaces of the display panel 100. However, when the display panel 100 can be cut by performing scribing only on one side, scribing may be performed only on one side. Further, scribing may be applied to both surfaces of the display panel 100 simultaneously or sequentially.

Subsequently, an external force such as vibrations or bending is applied to the display panel 100 thus cutting the display panel 100 at positions where scribing is made as schematically indicated by (3b) in FIG. 2. This step is called breaking. As a result, the display panel 100 is separated into the individual display devices 101 and undesired portions 102. As shown in the drawing, at the peripheral portions of the display devices 101, that is, portions of the display panel 100 where the display panel 100 is cut, the resin 40 is not temporarily hardened and remain soft. Accordingly, the resin 40 does not interrupt breaking of the display panel 100 so that sharp and favorable cutting surfaces are obtained. That is, it is sufficient to cut the display panel 100 at positions corresponding to the second portions 42. The undesired portions 102 are discarded, or are collected as resources when necessary and are recycled. The display device 101 is a part which becomes a product, and is conveyed to the heating device 7 by a delivery-side conveying device 10.

The final step is a heating step indicated by (4) in FIG. 2. In this step, the display device 101 is heated by the heating device 7 so that the resin 40 is completely hardened. In the drawing, in the display device 101, an inner region 43 which was the first portion 41 is completely hardened by the heating step which comes after temporary hardening in the radiation step. Accordingly, the inner region 43 is a portion which is hardened by both the radiation of ultraviolet rays and heating. On the other hand, ultraviolet rays are not radiated to a region 44 which was the second portion 42 in the radiation step. Accordingly, the region 44 becomes a portion which is hardened only by heating. As the position where the display panel 100 is cut, a layer made of the resin 40 exhibits such composition. Accordingly, on at least one side of the display device 101, the region 44 at the edge portion of the layer of the resin 40 is hardened only by heating, while the region 43 inside the region 44 is hardened also by the radiation of ultraviolet rays. Here, when the resin 40 is hardened due to the radiation of ultraviolet rays or the like, some molecules are subjected to a chemical change except for polymerization and cross-linking such as breaking of molecular chains which constitute the resin 40. Accordingly, some difference exists in composition between the inner region 43 and the region 44 at the edge portion.

As described previously, provided that no problem arises in the separation step, there arises no problem in slightly hardening the second portion 42 by also applying ultraviolet rays to the second portion 42. Eventually, the region 44 at the edge portion exhibits a higher thermal hardening rate and a lower ultraviolet-ray hardening rate compared to the inner region 43. The same goes for a case where electromagnetic waves, radioactive rays or electron beams except for that ultraviolet rays are used in the radiation step.

When the hardening of the resin 40 is finished in this manner, each display device 101 is conveyed to the delivery part 8 by the delivery-side conveying device 10. Each display device 101 is, thereafter, conveyed to a downstream step by a conveying device such as a conveyer not shown in the drawing, electronic circuits such as drivers and a frame are mounted on the display device 101, and the display device 101 is shipped as a product by way of inspection and the like.

Here, in the above-mentioned embodiment, the explanation has been made with respect to the case where the organic electroluminescence display device is used as the display device 101. The organic electroluminescence display device is roughly classified into two types of display devices consisting of a top-emission-type display device which takes out emitted light from a sealing substrate side and a bottom-emission-type display device which takes out emitted light from an element substrate side. This embodiment is applicable to both the top-emission-type display device and the bottom-emission-type display device. In the top-emission-type display device, it is necessary to form at least the sealing substrate 30 and the resin 40 using a transparent material. On the other hand, in the top-emission-type display device, the element substrate 20 is transparent.

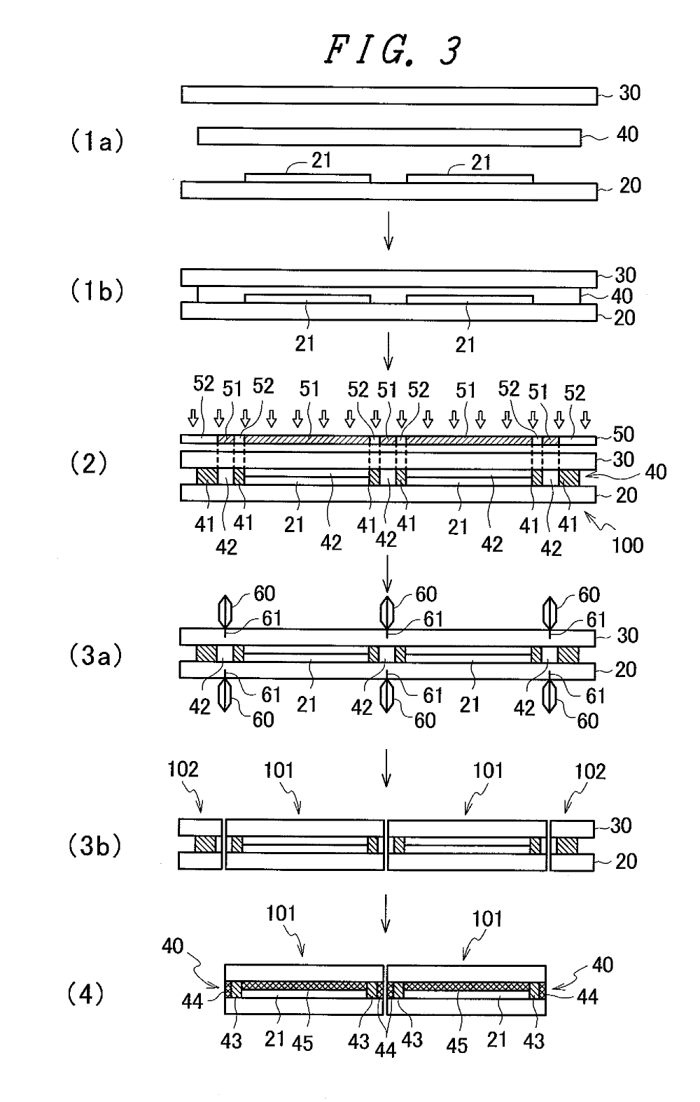

FIG. 3 is a view for explaining a manufacturing method of a display device 101 according to a second preferred embodiment of the present invention. This embodiment is substantially equal to the first embodiment except for that a shape of a mask 50 used in a radiation step of this embodiment differs from the a shape of the corresponding mask 50 used in the radiation step of the first embodiment. Accordingly, in the drawing, parts which are identical with the parts of the first embodiment are given the same symbols and their detailed explanation is omitted.

In this embodiment, in the radiation step indicated by (2) in FIG. 3, ray blocking portions 51 of the mask 50 are formed so as to also cover display regions 21. Such structure is adopted for preventing breaking or a change of characteristics of minute electronic circuits including a thin film transistor formed in the display region 21 which may be caused by the radiation of ultraviolet rays. As a result, as shown in the drawing, second portions 42 are formed also on portion of a resin 40 corresponding to the display regions 21.

Thereafter, in a display device 101 which is obtained through a separation step and a heating step which follow the above-mentioned radiation step, as shown in the drawing, on at least one side of the display region 21, a region 44 which constitutes an edge portion of a layer made of the resin 40 is hardened only by heating, and a region 43 which is arranged inside the region 44 is hardened also by the radiation of ultraviolet rays, and a region 45 which is arranged inside the region 43 and corresponds to the display region 21 are hardened only by heating.

It is needless to say that also in this embodiment, in the same manner as the first embodiment, provided that no problem arises in the separation step, the second portion 42 may be slightly hardened by also applying ultraviolet rays to the second portion 42. Accordingly, the region 44 at the edge portion and the region 45 corresponding to the display region 21 exhibit a higher thermal hardening rate and a lower ultraviolet-ray hardening rate compared to the inner region 43. Further, in the same manner as the first embodiment, electromagnetic waves, radioactive rays or electron beams other than ultraviolet rays may be used in the radiation step.

What is claimed is:

1. A manufacturing method of a display device comprising the steps of:
forming a display panel by sandwiching a resin which is hardened by any one of electromagnetic waves, radioactive rays and electron beams and heat between an element substrate having a display region in which a plurality of light emitting elements are formed and a sealing substrate in such a manner that the resin covers the display region;
radiating at least one of electromagnetic waves, radioactive rays and electron beams to the display panel thus hardening first portions of the resin and leaving second portions of the resin in a state softer than the first portions;
separating the display panel at positions corresponding to the second portions; and
heating the separated display panel thus further hardening the resin.

2. The manufacturing method of a display device according to claim 1, wherein the element substrate has a plurality of display regions, and the second portions include portions each of which is sandwiched between every two display regions out of the plurality of display regions.

3. The manufacturing method of a display device according to claim 1, wherein the resin covers the display regions and the second portions include the display regions.

4. The manufacturing method of a display device according to claim 1, wherein at least said one of electromagnetic waves, radioactive rays and electron beams is blocked partially in the radiation step thus leaving the second portions.

5. The manufacturing method of a display device according to claim 1, wherein in the separation step, the display panel is separated by applying scribing to at least one of the element substrate and the sealing substrate and, thereafter, by breaking the display panel.

6. A manufacturing apparatus of a display device comprising:
a panel forming device which forms a display panel by sandwiching a resin which is hardened by any one of electromagnetic waves, radioactive rays and electron beams and heat between an element substrate having a display region in which a plurality of light emitting elements are formed and a sealing substrate in such a manner that the resin covers the display region;
a radiation device which radiates at least one of electromagnetic waves, radioactive rays and electron beams to the display panel thus hardening first portions of the resin and leaving second portions of the resin in a state softer than the first portions;
a separation device which separates the display panel at positions corresponding to the second portions; and
a heating device which heats the separated display panel thus further hardening the resin.

7. The manufacturing apparatus of a display device according to claim 6, wherein the radiation device partially blocks at least said one of electromagnetic waves, radioactive rays and electron beams.

8. The manufacturing apparatus of a display device according to claim 6, wherein the separation device separates the display panel by applying scribing to at least either one of the element substrate and the sealing substrate and, thereafter, by breaking the display panel.

9. A display device comprising:
an element substrate which includes a display region in which a plurality of light emitting elements are formed;
a sealing substrate; and
a resin layer which is sandwiched between the element substrate and the sealing substrate and covers the display region, wherein
on at least one side of the display device, a region at an edge portion of the resin layer exhibits a higher thermal hardening rate and a lower radiation hardening rate attributed to at least one of electromagnetic waves, radioactive rays and electron beams compared to a region inside the region at the edge portion of the resin layer.

10. The display device according to claim 9, wherein a region of the resin layer which corresponds to the display region exhibits a higher thermal hardening rate compared to the region inside the region at the edge portion of the resin layer.
